(19) United States
(12) Patent Application Publication
(10) Pub. No.: US 2005/0016908 A1
(43) Pub. Date: Jan. 27, 2005

(54) Apparatus for the separation and removal of liquid borne solid waste

(75) Inventor: Thomas Kerl, Muhlhausen (DE)

Correspondence Address: DORITY & MANNING, P.A., POST OFFICE BOX 1449, GREENVILLE, SC, 29602-1449, US

(73) Assignee: Hans Huber AG Maschinen-und Anlagenbau

(21) Appl. No.: 10/858,568

(22) Filed: Jun. 1, 2004

(30) Foreign Application Priority Data
Jun. 2, 2003 (DE) 103 25 115.4

(51) Int. Cl. B01D 33/00

(52) U.S. Cl. 210/158; 210/160

(57) ABSTRACT

An apparatus for the separation and removal of solid waste material from a flowing liquid (2), for instance, wastewater, includes two endless, circulating chains (7), which are partially immersed in the liquid. The chains exhibit links (15) which, by means of pivotal joints (16) are bound together. Between the two chains (7) are placed sieve elements (8) which, respectively, are rigidly affixed to each link (15). Successive sieve elements (8) overlap each other in the running direction of the chain (7) in the area of the pivotal joint (16) of the links (15).

### FIELD OF THE INVENTION

The present invention concerns an apparatus for the separation and removal of waste material from a flowing liquid, for example from wastewater, having two continuous, circulating chains which are partially immersed in the liquid, wherein the chains respectively have connecting links, which are pivotally bound together, and between the said links are sieve elements, each side of which is affixed to a link.

### BACKGROUND

An endless, conveying, filter band for the mechanical cleaning of liquid, contaminated by solid waste and flowing in a channel has been made known by EP 0 676 227 B1. Such apparatuses principally serve for the mechanical cleaning of flowing wastewater, whereby the lower portion of the apparatus is immersed in the flowing liquid. Sieve elements, which are affixed to the apparatus, allow the through-flow of wastewater, whereby the contaminating material is captured on the sieve elements and said material is brought upward and out of the liquid. In order that larger solid pieces can be removed from the liquid as well as fine grained particulate, filter elements are positioned at a constant, small distance from each other. The so constructed filter elements possess, however, surfaces, which in the area of a turnaround are caused to move on top of one another, which can lead to the crushing of collected contamination. These locations must be repeatedly cleaned, in order to assure correct functioning of the apparatus. Beyond this, the individual filter elements must be very exactly aligned, one with the other, for the purpose of maintaining equal separation distances and thus, in a predetermined manner, assure the removal of the solid waste even from between the filtering elements.

DE 42 00 366 C2 discloses a similar apparatus for the separation and removal of solid waste, which apparatus operates with an endless chain arrangement, on which sievelike elements are affixed. Every other one of the sieve elements is pivotally attached to the chain and accordingly tips, upon reaching the upper turnaround pulley, that is, when the chain turns again towards the bottom of the liquid. A disadvantageous factor of this design, is that the sieve elements must be movable and thus, in the case of such contamination as may be expected, the sieve elements must be cleaned, in order to remain functional. Moreover, when the deposition of contamination extends itself to non-pivoting sieves, it is possible that fissures are formed between the individual sieve elements. Such depositions, depending on the amount of contamination, can be of varying severity, and thus a uniform filtering process is not reliably served thereby. Besides this, the chain structure is not sealed off, so that solid waste matter from the liquid can flow through and around the chain. In such an arrangement, the chain itself can become obstructed and be reduced in its functionality.

### SUMMARY OF THE INVENTION

Thus, on this account, a purpose of the present invention is to create an apparatus for the removal of waste out of a flowing liquid, which apparatus has a uniform cleaning action and moreover is predominately economical in maintenance costs. Additional objects and advantages of the invention will be set forth in detail in the following description, or may be obvious from the description, or may be learned through practice of the invention.

This purpose is achieved with apparatuses having the features of the independent appended claims.

In one apparatus in accord with the invention for the separation and the removal of solid waste from a flowing liquid, for example, from waste water, two parallel running, endless chains are present, which immerse themselves in the liquid. Each of the chains possesses links, which are pivotally connected together. Between parallel chain links are placed sieve elements, which are respectively affixed to each link. Avoided in this arrangement, is that the sieve elements would themselves execute random movements and that the waste material would in any way influence the functional positioning of the sieve elements. The sieve elements, accordingly, are bound firmly to the carrying links and are rigid in relation thereto.

In order that the filtering of the waste material can be done by the sieve elements in a uniform manner, it has been inventively provided that successive, neighboring sieve elements overlap in the travel direction of the chain links. In the case of motion of the chain between two turnaround pulleys, that is, in a straight line run of the chain, by the described means an entirely, complete retention of the collected waste is achieved. By the overlapping of the sieve elements, a sort of labyrinthine sealing is created, whereby passage of liquid is restricted, and especially, it becomes impossible for solid waste material to migrate between two sieve elements. Most of the liquid, with this overlap arrangement, is compelled to pass through the sieve element itself. The result of this is a uniform filtering procedure of the solid waste material from the liquid in accord with provided pore openings in the sieve elements.

In the zone of the turnarounds of the chain, in order to permit the endless chain to travel once again into the liquid, or, conversely, to emerge therefrom, the overlapped structure must open itself, more or less, to an extent allowable by the diameters of the turnaround pulleys and the design of the overlapping surfaces. The construction permitting this opening settles the design measure as to whether, even at a turnaround, an overlapping as well as a type of labyrinthine sealing could be brought about or if an intervening space between two neighboring sieve elements must be opened. Due to the effect that first, the neighboring sieve elements, because of their overlapping, prevent waste material from penetrating through the apparatus in any significant quantity, and second, by the movement of the sieve elements within their overlap at the turnaround, a cleaning action is created which allows maintenance of the apparatus to be of an especially low cost and also to be reliable in function.

Quite especially advantageous is a constructive measure, wherein the neighboring sieve elements overlap without touching. Abrasive action or damage of the edges of the sieve elements is predominately avoided by making use of this construction. The filter effect, in any case, is still preserved, if the overlapped edges of the sieve elements lie very close to one another, when running as a chain in a straight line, yet remain without touching one another.

An especially advantageous labyrinthine effect is created if the overlapping sieve elements, in the straight-line run of the chain, form an essentially enclosed hollow space, even when the sieve elements necessarily do not touch each other. Solid waste material can scarcely migrate through the sieve elements. The cleaning action, relative to the flowing liquid, on this account, is especially great.

Should the overlapping sieve elements in the turnaround zone of the chain form either an open hollow space or an essentially non-interrupted, continuously running surface, then the cleaning of the hollow space becomes very easy. At the turnaround structure above the liquid, it is possible to install certain cleaning devices in such a way that they direct their action to the cleaning of the overlapping zones. At the turnaround pulley of the chain immersed within the liquid, the cleaning can take place by the flowing liquid or by the motion of the sieve elements alone without additional aid.

As a cleaning means for the apparatus, it is of advantage if, at the upper turnaround of the chain, a specially designed, rotary brush is placed. The brush then, in this location, cleans not only the sieve elements themselves, but also the now open hollow space. In accord with the design, the brush also cleans the otherwise continuous surface of the sieve elements, even in the area of their overlapping ends.

It is of advantage if the sieve element lies principally outside of the plane of the chain. By this design, the opening of the overlapping of two neighboring sieve elements needs no special, constructive measures to be installed in the area of the turnaround of the chain.

An invented sieve element can be very simply fabricated, if the sieve element itself possesses a perforated sieve surface. In such a case, the porosity can be selected to be custom fit to the type of the solid waste material which is to be removed from the liquid. Beyond this, certain areas can exhibit a pore distribution pattern, while other portions of the exposed surface of the sieve element remain without perforation.

In order to substantially seal the overlapping areas, it is of advantage if the ends, which are proximal to one another, remain without perforations. By this means, the labyrinthine effect is undisturbed. Further, in this case, contamination cannot penetrate between the sieve elements of the apparatus.

In order to obtain a particularly stable sieve element, and at the same time, to create a surface commensurate with the overlapping, it is advantageously provided that at least one end of the sieve element be offset by bending in the direction of the immediate successive element. The manufacture of the sieve elements, by observing this operation, can be relatively inexpensive.

In order to achieve a particularly high degree of filtering on the part of the sieve, it is of advantage if the sieve element be bulged outward from the plane of the chain. In this way, the fortunate effect is that the solid waste is easily retained on the sieve element and can be removed upward and out of the liquid.

In order to fasten the sieve element particularly simply onto the chain links, those ends of the sieve element which are proximal to the chain are encapsulated within a cover. By means of the cover, the sieve element is fastened onto the chain link. In particular, it is bolted thereon. With the sieve element so secured, in each case, a link is now connected to the sieve element ends and the sieve element becomes an integral, component of the two chains of the apparatus. By means of the transverse sieve elements, the two chains are unified in action and bound in parallel with one another. In this way, rigid units are created, which can be angularly displaced at the pivot points of the links which, in any case, are axially aligned, thereby allowing turnaround at the upper and lower pulleys.

In order to further reinforce the sieve element, on that side of each element which is proximal to the link, at least one, preferably several, metal support webs are installed. These reinforcement webs, in their function, serve as a part of the hollow space enclosure, similar to a wall, which is created upon the overlapping of the sieve elements. The reinforcement webs further act in such a manner that the sieve elements can also withstand the kinetic flow pressure of the liquid without bending. Undesirable bending would permit a random sized opening to occur between the sieve elements.

In order to achieve a particularly strong connection of the metal reinforcement webs with the sieve element, it is advantageous if the reinforcement web is fastened to a non-perforated surface of the sieve element, most advantageous, if welded thereon.

It is of particular advantage if at least a selection of sieve elements, for example, every fifth sieve element, possesses a coarse rake on that side which is remote from the chain. With the aid of the coarse rake, it is possible that even larger and heavier pieces of solid waste carried by the liquid can be removed therefrom. Such heavier particles are captured by rakes which stand somewhat at right angles from the sieve elements and are lifted upward.

In the case of an apparatus for the separation and the removal of solid waste contamination from a flowing liquid, wherein the apparatus has two endless, circulating chains comprised of pivotally interconnected links, and between the chains are placed sieve elements, which elements are attached to one link of each chain, it is both inventive and to the purpose if, between the ends of the sieve elements, which are proximal to the chains, a wall is placed which covers the chain. Within this wall, a cleaning brush and/or a sealing brush can be advantageously placed which is independent of the overlapping of the sieve elements.

Obviously, it is of particular advantage if the arrangement of the brushes and the overlapping of the sieve elements can be employed as a combined operation, since in such an arrangement a special effect can be achieved, in that neither between the individual sieve elements, nor to the sides of the apparatus, can solid waste material bypass and contaminate the downstream flow of water. By the placement of the brushes on the already close-fit, constructed location between the apparatus housing wall and the sieve elements, which latter are thereto relatively movable, a particularly good cleaning action is achieved. Any passage past the invented apparatus by separated solid waste is predominately blocked by the brushes.

The cleaning action of the brushes becomes especially intensive when they are so located that they lie with the tips of their bristles on the links of the chain and touch with their sides on the housing wall and/or the ends of the sieve elements, especially on the described covers.

In this way, the openings separating the sieve elements, the chain links, and the housing wall are nearly completely filled with brush bristles, producing a frictional contact, so that a satisfactory sealing function is achieved relative to the solid waste material.

For an even superior sealing function, it is well if the brush bristles lie only on the links whereon the sieve elements are fastened. These links which are affixed to the sieve elements are those which have first contact with the flowing liquid and thus, in this primary position, can immediately bring about a reliable sealing effect in combination with the brush bristles.

If the brush is placed on that side of the sieve element which is proximal to the housing wall, then the brush bristles can penetrate into the opening between the sieve element and the housing wall, with the result that such opening is additionally sealed.

In most cases, it is sufficient if the brushes are placed on that side of the separation apparatus which principally faces the flow of the liquid in the liquid immersed part of the apparatus. The remaining parts of the separation apparatus must not be obstructed by the brushes nor be shielded against the solid waste.

### BRIEF DESCRIPTION OF THE DRAWINGS

In the following, the invention will be described and explained in greater detail with the aid of embodiments. There is shown in:

FIG. 1 a sectional side view of an invented apparatus,

FIG. 2 a detailed, sectional view of the sieve elements on the chain, and

FIG. 3 a detailed, sectional presentation of the cleaning and sealing brush.

### DETAILED DESCRIPTION

Reference will now be made in detail to one or more embodiments of the invention, an example of which is shown in the drawings. The embodiments are provided by way of explanation of the invention, and not as a limitation of the invention. The invention includes modifications and variations to the embodiments described herein.

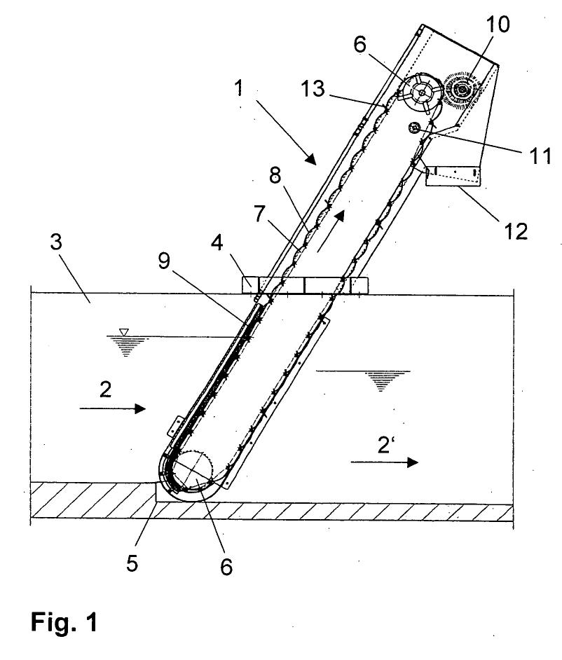

FIG. 1 shows a sectioned, profile view through a separation and removal apparatus 1. The separation apparatus 1 is partially immersed in a liquid 2 flowing in the direction of the arrow in a channel 3. The liquid 2, upstream of the separation apparatus 1, has a higher level than downstream, due to the flow resistance of the separation apparatus 1. Consequently, liquid 2 suffers a delaying loss in velocity through the invented apparatus 1. The separation apparatus 1 is affixed to the channel 3 by a holder 4. In order to avoid accumulation solid wastes, the separation apparatus is erected upon an indented step 5 in the bottom of the channel 3. This step-down contour also favors improved hydraulic relationships.

The separation apparatus 1 consists essentially of a conveyor band which continuously circulates between two turnaround pulleys 6. The endless conveyor band itself comprises two chains 7 which run parallel to one another, of which, in the presentation of FIG. 1, principally only one chain can be seen in the profile. Between the two chains 7 are mounted sieve elements 8. On each chain 7 and in the zone of the lower, immersed turnaround pulley 6, a brush 9 is installed on that side which faces the oncoming liquid flow. The brush 9 cleans the chain 7 as well as functions as a sealing means protecting the clean liquid 2′, since the bristles of the brush 9 prevent solid waste from passing through between the separation apparatus 1 and the wall of the channel 3.

Near the upper turnaround pulley 6, is located an additional brush 10, which has a power drive. This brush 10 acts to remove such solid waste that has agglomerated on the separation apparatus 10 and the brush performs, simultaneously, a cleaning of the sieve elements 8. An additional cleaning function of the sieve elements 8 and therewith an impact removal of deposited waste material from the sieve elements 8 is carried out by a plurality of nozzles 11. These nozzles 11 eject liquid from the inside of the separation apparatus 1 against the said sieve elements 8 and thereby clean both the sieve perforations as well as the inside of the sieve element 8. The waste material loosened thereby and the cleaning water are conducted through a shaft 12 out of the separation apparatus 12, and to a (not shown) means of removal transport, or to a waste reservoir.

In order that heavier solid waste, such as stones, may be removed from the liquid 2, on every fifth sieve element 8 is placed a rake 13. The waste material is retained on the rake 13 and, in the course of the chain movement, passes over the turnaround pulley 6, allowing the heavy material, namely stones, to fall through the chute 12 into the (not shown) above mentioned removal means.

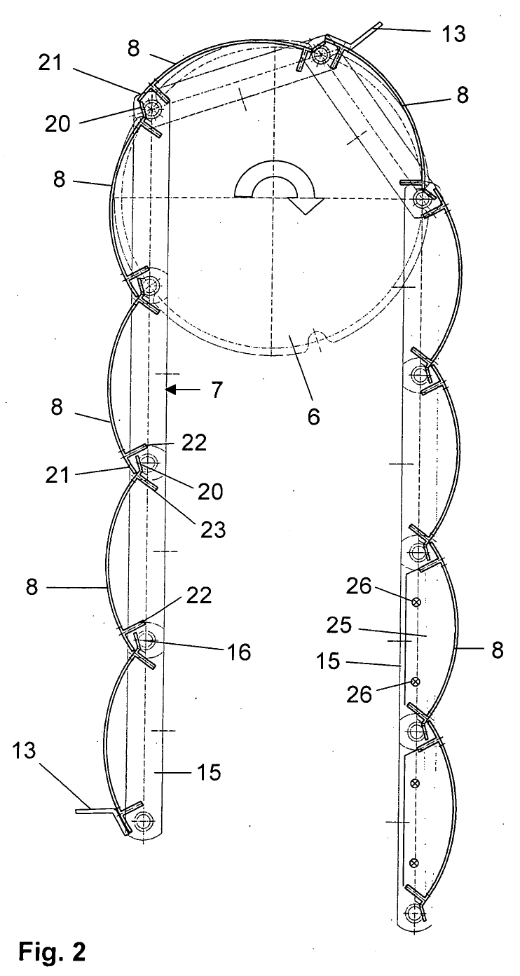

FIG. 2 shows a detail near the upper turnaround pulley 6 of the separation apparatus 1. The linkage axles 16, which pivotally bind the chain links 15 together, engage in recesses of the turnaround pulley 6. The links 15 possess, respectively, an elongation, which corresponds, essentially, to the length of a sieve element 8. In the zone of the linkage axles 16, two neighboring sieve elements 8 overlap one another, so that a kind of labyrinthine sealing is created in regard to the liquid 2 which is flowing against the sieve elements 8. The overlapping is formed by a bent end edge 20 of the leading sieve element 8 and the other end 21 of the following sieve element 8.

The surface of the sieve element 8 is bulged outward, so that its capture of the waste material is improved. The stability of the sieve element 8 is enhanced, first by the bent end 20 and second, by certain reinforcing, metal webs 22 and 23, which run along the bulging of the sieve element 8 and which abut the collection surface of the sieve element 8 proximal to the chain 7. The true filter surface of the sieve element is to be found between the two said reinforcement webs 22, 23. Where these are placed on the sieve element 8, the sieve element is not perforated, whereby, at the overlapping zones of the sieve element 8, the throughflow of the liquid 2 is considerably reduced and moreover, the fastening of the reinforcement web 22 is easier. Between the sieve element 8 ends 20 and 21 and the reinforcement web 22, a hollow space is created, which acts in the manner of a labyrinthine sealant. Furthermore, the end 21 of one sieve element 8 extends itself nearly to the surface of the other neighboring sieve element 8, so that even here, another sealing function is performed.

In the neighborhood of the turnaround pulley 6, the two ends 20 and 21 pass by each other in such a way, that the hollow space between the ends 20 and 21 and the reinforcement web 22 opens, and an essentially unbroken, continuous surface of the sieve element is formed. This surface can be very easily cleaned by the brush 10, so that upon the completed turnaround of the chain, the hollow space between the overlapping ends of the sieve element 8 is once again fully functional. By means of the sieve elements 8, which stand near to one another in this position, assurance is given that none of the solid waste material from the sieve elements 8 falls between the two chain ends and so into the already cleaned liquid 2′.

In order to hold the abrasive wear, as well as the development of noise, to the least possible level, the ends 20, 21 of the sieve element 8 do not touch one another, but rather run closely adjacent to one another. By means of this non-touching overlapping, in connection with the labyrinthine sealing, a penetration of solid waste material into the opening between the two sieve elements 8 is effectively prevented.

As an example for all sieve elements, FIG. 2 shows, respectively, on two sieve elements 8, the placement of a cover 25. In this manner, the sieve element 8 is closed off at its two ends which are proximal to the chains 7. The covers 25 are welded onto the sieve element 8. The cover 25, and therewith the sieve element 8, are held by bolts 26 onto a chain link 15, thus forming a firm binding of the sieve element 8 with the chain 7. The sieve element 8 and the link 15 thus form a rigid, integral unit.

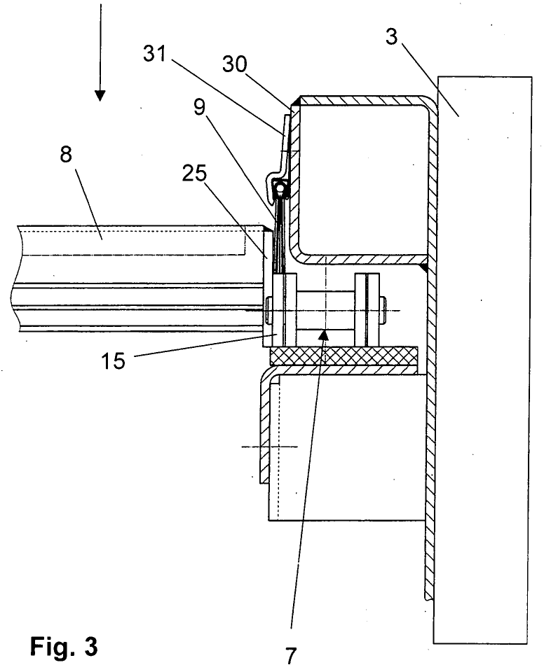

FIG. 3 shows an excerpt from the area of the immersed turnaround, in which a brush 9 is shown. The arrow, which is directed at the sieve element 8, indicates the direction of the liquid 2 flow against the sieve element 8. The brush 9 presses the brush bristles onto the link 15, which is attached to the cover 25 of the sieve element 8. Moreover, the brush 9 is placed in the opening between the cover 25 and a housing wall 30 where it serves the purpose of sealing this opening, so that contaminating particles in the liquid 2, which were to be separated out by the separation apparatus 1 cannot penetrate into the said opening. The brush 9, in this arrangement, is affixed to that side of the housing wall 31 by a metal clamp 31, which is proximal to the end of the sieve element 8 and its cover 25. In this way, a lateral stabilization of the bristle assembly of the brush 9 is achieved, whereby additionally the sealing is accomplished of the sieve element 8 in relation to the housing wall 30, which is placed on the channel.

The brush 9, in like manner to the overlapping zone of the individual sieve elements 8, takes care that the zone behind the sieve element 8 is substantially sealed off from solid wastes and thus an excellent cleaning of the liquid 2 can take place.

The present invention is not limited to the presented embodiment Changes can be made, especially in regard to the sieve elements, which would be alterations permissible within patent protection, and would be still in accord with the formulation of the patent claims.

For example, the overlapping of the sieve elements 8 need not be carried out in the here described art and manner with the same sieve elements 8, but also can be made differently with larger and smaller sieve elements 8, which likewise can allow an overlapping form. Principally, the current preferred embodiment of the invention was described in the present embodiment.

1-19. (Cancelled)

20. An apparatus for separation and removal of waste material from a liquid flow, said apparatus comprising:
at least two endless chains circulating between turnaround locations, said chains configured to be at least partially immersed in the flow path of the liquid, said chains comprising individual links pivotally attached at linkages;
a plurality of sieve elements disposed between at attached to each of said chains; and
wherein said sieve elements are arranged successively proximal to each other and have respective ends that overlap with said ends of adjacent said sieve elements at said linkages.

21. The apparatus as in claim 20, wherein said overlapping ends of adjacent said sieve elements are non-contacting at the overlap thereof.

22. The apparatus as in claim 20, wherein said overlapping ends of adjacent said sieve elements define a generally closed space along essentially straight runs of said chains.

23. The apparatus as in claim 22, wherein said overlapping ends of adjacent said sieve elements are shaped such that at said turnaround locations of said chains, said overlapping ends orient to define a generally non-interrupted continuous surface between said sieve elements.

24. The apparatus as in claim 23, wherein said generally closed space is opened upon orientation of said overlapping ends of said sieve elements at said turn-around locations.

25. The apparatus as in claim 24, further comprising a rotating brush disposed at one of said turnarounds at a location so as to clean said opened space.

26. The apparatus as in claim 25, wherein said brush is further configured to clean said non-interrupted continuous surface.

27. The apparatus as in claim 20, wherein said sieve elements extend above a plane defined between said chains.

28. The apparatus as in claim 27, wherein said sieve elements are bowed outwardly from said plane.

29. The apparatus as in claim 20, wherein said sieve elements comprise perforated sieve surfaces at least between said overlapping ends.

30. The apparatus as in claim 29, wherein said overlapping ends of said sieves are non-perforated.

31. The apparatus as in claim 20, wherein at least one end of said sieve elements is angled towards said overlapping end of said adjacent sieve element.

32. The apparatus as in claim 20, wherein said sieve elements comprise a cover on sides thereof adjacent said chains.

33. The apparatus as in claim 32, wherein said covers are affixed to said chain links.

34. The apparatus as in clam 20, wherein said sieve elements comprise reinforcing metal webs on sides thereof adjacent said chains.

35. The apparatus as in claim 34, wherein said sieve elements comprise perforated sieve surfaces at least between said overlapping ends, said reinforcing webs disposed on non-perforated areas of said sieve elements.

36. The apparatus as in claim 20, wherein at least one of said sieve elements comprises a rake element on a side thereof that is remote from said chain.

37. The apparatus as in claim 20, further comprising a housing at said turnaround location disposed for immersion in the liquid flow, and a brush disposed in said housing in an opening between sides of said sieve elements proximal to said chains and a side of said housing for cleaning portions of said sieve elements at said turnaround location and sealing said opening.

38. The apparatus as in claim 37, wherein said brush is disposed such that bristle tips thereof are in contact with said chain links and sides of said brush contacting said housing wall and said sides of said sieve elements.

39. The apparatus as in claim 38, wherein said bristle tips lie on said chain links on which said sieve elements are attached.
